(19) United States
(12) Patent Application Publication
(10) Pub. No.: US 2005/0104341 A1
(43) Pub. Date: May 19, 2005

(54) Occupant protecting device

(75) Inventor: Katsuyuki Sakai, Hikine-shi (JP)

Correspondence Address: FOLEY AND LARDNER;SUITE 500, 3000 K STREET NW, WASHINGTON, DC, 20007, US

(73) Assignee: TAKATA CORPORATION

(21) Appl. No.: 10/979,262

(22) Filed: Nov. 3, 2004

(30) Foreign Application Priority Data
Nov. 14, 2003 (JP) 2003-385326

(51) Int. Cl. B60R 21/22

(52) U.S. Cl. 280/730.1; 297/216.1

(57) ABSTRACT

An occupant protecting device includes a bag disposed on the upper side of the seat pan and being inflatable so as to press the front portion of the seat cushion from the lower side; and a gas generator for inflating the bag. The bag extends laterally widthwise of the seat pan, and the left and right ends of the bag are preferably connected to a seat pan respectively. The bag is arranged in such a manner that the swagging amount of the hip of the occupant into the seat cushion does not exceed 60 mm when the hip of the occupant is swagged into the seat cushion in a state in which the bag is inflated at the time of front collision of the vehicle and the front portion of the seat cushion is pressed from the lower side.

### BACKGROUND

The present invention relates to an occupant protecting device for protecting an occupant seated on a seat of a vehicle such as a motor vehicle at the time of collision, and more specifically, to an occupant protecting device configured to hold back the hip of the occupant especially at the time of front collision for preventing the body of the occupant from moving forward and downward.

As a system for protecting an occupant of a vehicle at the time of collision, an occupant protecting device which rises or hardens the front portion of the seat cushion at the time of collision of the vehicle in order to prevent a submarine phenomenon in which an occupant is apt to slip under the lower side of a lap belt at the time of the front collision even when the seat belt is attached is disclosed in Japanese Unexamined Patent Application Publication No. 2001-247010 (hereby incorporated by reference herein in its entirety).

In FIG. 34 in the above-described publication, a bag is crossed between a left side frame and a right side frame and a gas generator is disposed on the side of the side frame.

In the occupant protecting device disclosed in the above-described Japanese Unexamined Patent Application Publication No. 2001-247010, an index to fix the optimal position for arranging the bag (the position of the bag where an occupant can be protected most efficiently) is not clear.

### SUMMARY

According to an embodiment of the present invention occupant protecting device is provided. The device includes a bag disposed on the lower side of a seat cushion and being inflatable so as to press the front portion of the seat cushion from the lower side; and a gas generator for inflating the bag in case of emergency of a vehicle, wherein the bag is disposed at the position where the amount of swagging of the hip of an occupant who is seated on a seat and is held back by a lap belt does not exceed 60 mm at the time of collision of the vehicle.

According to another embodiment of the present invention, an occupant protection device, is provided. The occupant protection device includes an airbag positioned on the lower side of a seat cushion to extend laterally widthwise of the seat cushion and left and right ends of the airbag are connected to a seat pan; and a gas generator for inflating the airbag. The airbag is configured to evenly inflate between the left and right ends and push up a front portion of the seat cushion to prevent forward movement of a hip of an occupant.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a perspective view of a seat frame showing a structure of an occupant protecting device according to an embodiment of the present invention.

FIG. 2 is a vertical cross-sectional view of the seat frame showing the positional relation between the bag and the hip of the occupant.

### DESCRIPTION

Hereinafter, embodiments of the present invention will be described with reference to the attached drawings.

In the present invention, the term “occupant” designates a dummy doll AM50 used as an occupant for collision experiment of motor vehicles or the like.

In the occupant protecting device according to an embodiment of the present invention, the bag is preferably positioned so that the center point in the fore-and-aft direction and in the vertical direction when inflated is located within a range of 120-200 mm forwardly and 40-150 mm downwardly from the hip point of the occupant (AM50) seated on the seat and, more specifically, in the range of 140-180 mm forwardly and 60-130 mm downwardly from the hip point of the occupant.

According to an embodiment of the present invention, the bag extends laterally widthwise of the seat cushion, and the left and right ends of the bag are preferably connected to a seat pan respectively.

Generally, when a vehicle collides from the front in a state in which an occupant is seated on the seat of the vehicle and the hip of the occupant is held back to the seat by a lap belt (seat belt), the hip of the occupant is apt to move forward and obliquely downward by a resultant force of an inertia force in the forward direction and a tensile force generated on the lap belt (a force to tighten the hip of the occupant to the seat). In this case, the hip of the occupant turns downward about the contact portion with the lap belt as a center of rotation as if it slips through the lower side of the lap belt. Therefore, the hip of the occupant moves forward while swagging into the seat cushion of the seat.

The present inventors, after having devoted themselves to study using the dummy doll AM50 as the occupant, found that the amount of forward movement of the occupant at the time of collision of the vehicle is sufficiently reduced and an impact to be exerted to the occupant is sufficiently absorbed by disposing the inflatable bag between the seat cushion and the seat pan so that swagging of the hip of the occupant (AM50) into the seat cushion does not exceed 60 mm.

In the occupant protecting device of an embodiment of the present invention, since the bag is disposed at the position where the swagging amount of the hip of the occupant seated on the seat and held back by the lap belt at the time of collision of the vehicle does not exceed 60 mm, the forward movement of the occupant at the time of collision of the vehicle can be restrained sufficiently, and an impact to be applied to the occupant can also be absorbed sufficiently.

In an embodiment, by arranging the bag so that the center point in the fore-and-aft direction and in the vertical direction when inflated is located within a range of 120-200 mm forwardly and 40-150 mm downwardly from the hip point of the occupant (AM50) seated on the seat, the swagging amount of the hip of the occupant seated on the seat and held back by the lap belt at the time of collision of the vehicle may be controlled not to exceed 60 mm.

According to an embodiment of the occupant protecting device of the present invention, preferably, the bag extends laterally widthwise of the seat cushion, and the left and right ends of the bag are connected to the seat pan respectively. By extending the bag laterally widthwise of the seat cushion and connecting the left and right ends to the seat pan, the bag can be inflated evenly between the both ends thereof and hence the front portion of the seat cushion is pressed from the lower side thereof laterally evenly widthwise thereof.

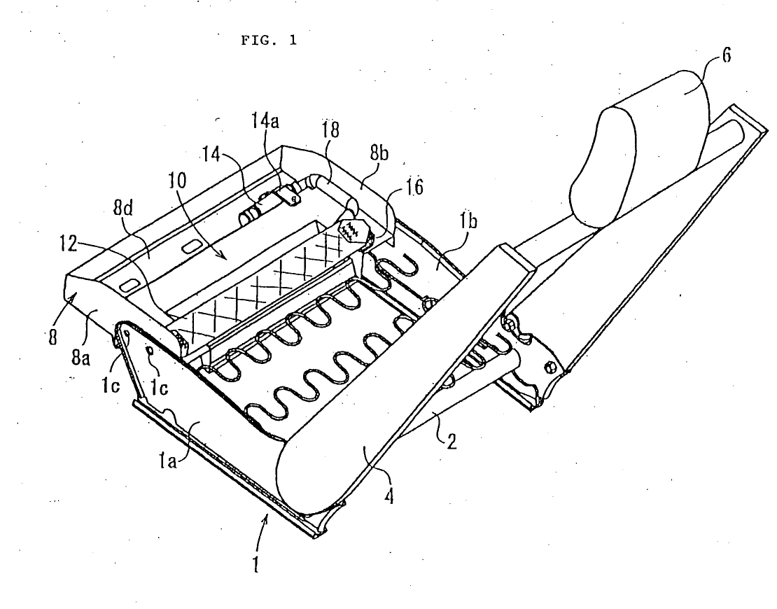

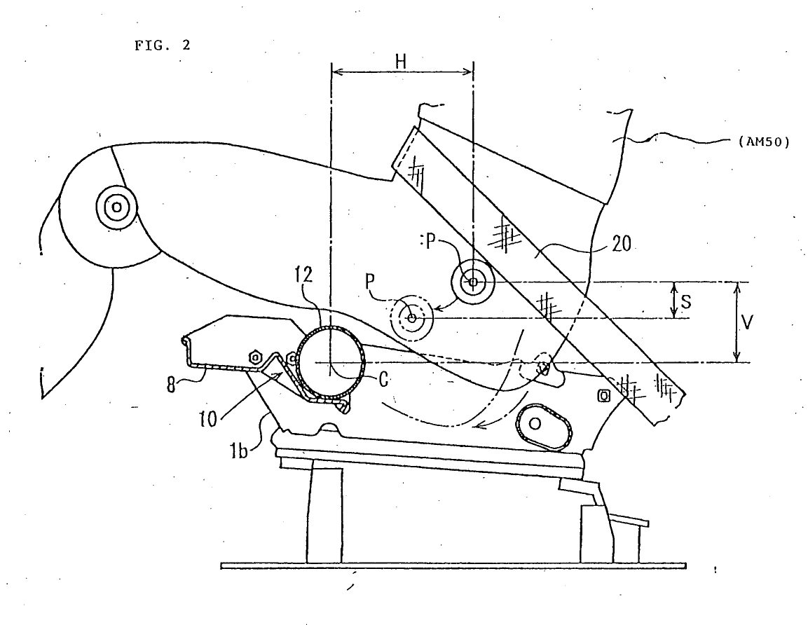

Referring now to the drawings, an embodiment of the present invention will be described. FIG. 1 is a perspective view of a frame of a seat provided with an occupant protecting device according to the embodiment of the present invention, and FIG. 2 is a vertical cross-sectional view of the seat frame showing a positional relation between the bag of the occupant protecting device and the occupant's hip.

The frame constituting the seat of the motor vehicle includes a base frame 1, and a back frame 4 rotatably joined to the base frame 1 via a supporting shaft 2 and a reclining device (not shown). A head rest 6 is mounted to the upper portion of the back frame 4.

The base frame 1 includes left and right side frames 1a, 1b. A seat pan 8 is crossed between the front portions of the side frames 1a, 1b. Side wall portions 8a, 8b overlapping the inner side surfaces (side surfaces of the side frames 1a, 1b opposing to each other) of the side frames 1a, 1b are provided so as to extend upright at laterally both ends of the seat pan 8. The side wall portions 8a, 8b are overlapped on the inner side surfaces of the side frames 1a, 1b respectively, and the seat pan 8 is fixed between the side frames 1a, 1b by a fixture 1c such as a bolt being tightened so as to penetrate through both of them.

Although not shown, a seat cushion and a seat back, formed of urethane or the like, are mounted to the base frame 1 and the back frame 4. The seat pan 8 is disposed on the lower side of the front portion of the seat cushion.

An occupant protecting device 10 includes a bag 12 disposed on the upper side of the seat pan 8 and being inflatable so as to press the front portion of the seat cushion from the lower side, and a gas generator 14 for inflating the bag 12. The bag 12 extends laterally widthwise of the seat pan 8, and the left and right ends thereof are connected to the seat pan 8 via anchors 16 fixed on the upper surface of the seat pan 8.

The gas generator 14 is column shape in the present embodiment, and is arranged along the upper surface of the seat pan 8 with its axial direction coincided with the lateral widthwise direction of the seat pan 8. In the embodiment, the upper surface of the seat pan 8 is formed into a recessed portion 8d which is lower at the front end by the amount corresponding to the height of the gas generator 14 from the upper surface, and the gas generator 14 is disposed in the recess 8d thereof. Reference numeral 14a in FIG. 1 shows a bracket for fixing the gas generator 14 in the recess 8d.

The gas generator 14 is connected to the bag 12 via a pipe 18. The pipe 18 is disposed along the upper surface of the seat pan 8.

In the present embodiment, the bag 12 includes a cylindrical bag body, and a cylindrical mesh webbing surrounding the bag body. The bag body is an elongated folded body. The mesh webbing is composed of a knitted fabric which expands in the radial direction, but hardly expands in the longitudinal direction (laterally of the seat). The both ends of the mesh webbing are joined to the anchors 16 respectively.

The pipe 18 is connected at one end to the gas injection port of the gas generator 14 and is inserted at the other end into the mesh webbing from one end of the mesh webbing, and is connected to one end of the bag body in the mesh webbing.

In this occupant protecting device 10, the bag 12 as shown in FIG. 2 is arranged with respect to a hip point P of the occupant (AM 50) in a state of being seated on the seat and held back on the seat at the hip by a lap belt 20 (seat belt) in such a manner that a distance H from the hip point P to the center point of the bag 12 in an inflated state in the fore-and-aft direction and in the vertical direction (the center point of the bag) C toward the front (in the horizontal direction) falls in the range of 120-200 mm and, more preferably, 140-180 mm, and a distance in the downward direction (in the vertical direction) V falls in the range of 40-150 mm and, more preferably, 60-130 mm.

By arranging the bag 12 as described above, as shown by an alternate long and two short dash line in FIG. 2, when the hip of the occupant is swagged into the seat cushion in a state in which the bag 12 is inflated and the front portion of the seat cushion is pressed from the lower side at the time of the front collision of the vehicle, a swagging amount of the hip of the occupant into the seat cushion (component in vertical direction) S does not exceed 60 mm.

The value S preferably falls within the range of 10-60 mm, preferably in the range of 20-60 mm, and more preferably in the range of 30-50 mm.

In this embodiment, a vent hole (not shown) is provided on the bag 12, so that gas is discharged through the vent hole to absorb the impact when the inflated bag 12 received the occupant via the seat cushion. The vent hole may be provided with gas discharge control means for controlling discharge of gas from the bag 12 so as to prevent the hip of the occupant from swagging into the seat cushion by an extent exceeding 60 mm.

The operation of the occupant protecting device 10 will be described.

When the front collision of the vehicle is detected, the gas generator 14 is activated and injects gas. Gas injected from the gas generator 14 is flown into the bag 12 via the pipe 18, and inflates the bag 12. Consequently, the front portion of the seat cushion is pushed up or hardened, so that the forward movement of the hip of the occupant is restrained.

As described above, the hip of the occupant (AM50) in the state of being held back at the hip by the lap belt 20 to the seat is apt to move forward and obliquely downward by a resultant force of an inertia force in the forward direction and a tensile force generated on the lap belt 20 (a force to tighten the hip of the occupant to the seat). In this case, the hip of the occupant turns downward about the contact portion with the lap belt 20 as a center of rotation as if it slips through the lower side of the lap belt 20. Therefore, the hip of the occupant moves forward while swagging into the seat cushion of the seat.

In this occupant protecting device 10, since the inflated bag 12 is disposed at the position where the swagging amount S of the hip of the occupant seated on the seat does not exceed 60 mm, the forward movement of the hip of the occupant can be restrained sufficiently, and the impact to be applied to the occupant can also be absorbed sufficiently.

The above-described embodiment is shown simply for the sake of illustration, and the present invention is not limited to the above-described embodiment.

It is an object of the present invention to provide an occupant protecting device in which an index for fixing the optimal position for arranging a bag is clarified.

The priority application, Japanese Patent Application No. 2003-385326, filed Nov. 14, 2003, including the specification, drawings, claims and abstract, is incorporated herein by reference in their entirety.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

1. An occupant protecting device including:
a bag disposed on the lower side of a seat cushion and being inflatable so as to press the front portion of the seat cushion from the lower side; and
a gas generator for inflating the bag in case of emergency of a vehicle,
wherein the bag is disposed at the position where the amount of swagging of the hip of an occupant who is seated on a seat and is held back by a lap belt does not exceed 60 mm at the time of collision of a vehicle.

2. The occupant protecting device according to claim 1, wherein the bag is positioned so that the center point in the fore-and-aft direction and in the vertical direction when inflated is located within a range of 120-200 mm forwardly and 40-150 mm downwardly from the hip point of the occupant seated on the seat.

3. The occupant protecting device according to claim 1, wherein the bag extends laterally widthwise of the seat cushion, and the left and right ends of the bag are connected to a seat pan respectively.

4. The occupant protection device according to claim 1, wherein the gas generator comprises a column shape and is arranged along an upper surface of a seat pan, and wherein the axial direction of the gas generator coincides with a lateral widthwise direction of the seat pan.

5. The occupant protection device according to claim 1, wherein the bag comprises a bag body and a mesh webbing surrounding the bag body, the mesh webbing being configured to expand in a radial direction.

6. The occupant protection device according to claim 2, wherein the center point in the fore-and-aft direction when the airbag is inflated is located within a range of 140-180 mm forwardly from the hip point of the occupant seated on the seat.

7. The occupant protection device according to claim 2, wherein the center point in the vertical direction when the airbag is inflated is located within a range of 60-130 mm downwardly from the hip point of the occupant seated on the seat.

8. The occupant protection device according to claim 2, wherein the bag extends laterally widthwise of the seat cushion, and the left and right ends of the bag are connected to a seat pan respectively.

9. An occupant protection device, comprising:
an airbag positioned on the lower side of a seat cushion to extend laterally widthwise of the seat cushion and left and right ends of the airbag are connected to a seat pan; and
a gas generator for inflating the airbag,
wherein the airbag is configured to evenly inflate between the left and right ends and push up a front portion of the seat cushion to prevent forward movement of a hip of an occupant.

10. The occupant protection device according to claim 9, wherein the airbag is configured to limit a swagging amount of a hip of an occupant into the seat cushion to a range of 10 to 60 mm.

11. The occupant protection device according to claim 9, wherein the airbag is configured to limit a swagging amount of a hip of an occupant into the seat cushion to a range of 20 to 60 mm.

12. The occupant protection device according to claim 8, wherein the airbag is configured to limit a swagging amount of a hip of an occupant into the seat cushion to a range of 30 to 50 mm.
